(19) United States
(12) Patent Application Publication
(10) Pub. No.: US 2025/0364733 A1
(43) Pub. Date: Nov. 27, 2025

(54) BASE STATION ANTENNAS WITH DUAL POLARIZED RADIATING ELEMENTS HAVING FEED STALKS ARRANGED TO GENERATE ORTHOGONAL ELECTRIC FIELD DIRECTIONS

(71) Applicant: Outdoor Wireless Networks LLC, Richardson, TX (US)

(72) Inventors: Xun Zhang, Suzhou (CN); Shuang Ji, Suzhou (CN); Hangsheng Wen, Suzhou (CN); Xiaotuo Wang, Suzhou (CN)

(21) Appl. No.: 19/210,129

(22) Filed: May 16, 2025

(30) Foreign Application Priority Data
May 23, 2024 (CN) 202410649449.4

(51) Int. Cl. H01Q 25/00; H01Q 1/24; H01Q 5/50

(52) U.S. Cl. CPC H01Q 25/001; H01Q 1/246; H01Q 5/50

(57) ABSTRACT

Dual polarized radiating elements having feed stalks configured to generate orthogonal electric field directions. The dual polarized radiating elements can be a center-fed cross-dipole radiating element with four dipole arms and with the feed stalk arranged to overlap two of the dipole arms in the forward direction but does not overlap the other two dipole arms. The four dipole arms can be provided by a dipole radiator printed circuit board. The feed stalk can be a single printed circuit board feed stalk configured to provide the signal traces and ground lines. The center of the feed stalk does not overlap the center of the dipole radiator printed circuit board.

### BACKGROUND

The present invention generally relates to radio communications and, more particularly, to base station antennas for cellular communications systems.

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly. In many cases, each base station is divided into “sectors.” In one common configuration, a hexagonally shaped cell is divided into three 120° sectors in the azimuth plane (i.e., a plane parallel to the plane defined by the horizon that bisects the base station antenna), and each sector is served by one or more base station antennas that provide coverage throughout the 120° sector. Base station antennas that provide less than omnidirectional (360°) coverage in the azimuth plane are often referred to as “sector” base station antennas. The antenna beams formed by both omnidirectional and sector base station antennas are typically generated by linear or planar phased arrays of radiating elements that are included in the antenna.

In order to accommodate the increasing volume of cellular communications, cellular operators have added cellular service in a variety of new frequency bands. While in some cases it is possible to use a single array of so-called “wide-band” or “ultra-wide-band” radiating elements to provide service in multiple frequency bands, in other cases it is necessary to use different arrays of radiating elements to support service in the different frequency bands.

As the number of frequency bands has proliferated, and increased sectorization has become more common (e.g., dividing a cell into six, nine or even twelve sectors), the number of base station antennas deployed at a typical base station has increased significantly. However, due to, for example, local zoning ordinances and/or weight and wind loading constraints for the antenna towers, there is often a limit as to the number of base station antennas that can be deployed at a given base station. In order to increase capacity without further increasing the number of base station antennas, so-called multi-band base station antennas have been introduced which include multiple arrays of radiating elements. Multi-band base station antennas are now being developed that include arrays that operate in three (or more) different frequency bands and often within multiple sub-bands in one or more of these frequency bands. Unfortunately, the different arrays can interact with each other, which may make it challenging to implement such a multi-band antenna while also meeting customer requirements relating to the size (and particularly the width) of the base station antenna.

### SUMMARY

Pursuant to embodiments of the present invention, dual polarized radiating elements are provided that each have a single feed stalk printed circuit board that feeds a pair of dipole radiators. The feed stalk is arranged so that the dipole radiators are fed by orthogonal feed currents.

The front portions of the feed stalks of the dual polarized radiating elements providing signal and ground connections can be arranged to reside offset a distance from a center of the dipole radiators to facilitate feeding the dipole radiators with orthogonal feed currents.

Embodiments of the present invention are directed to a base station antenna that includes: a plurality of dual polarized radiating elements, each dual polarized radiating element comprising: a first dipole radiator having a first dipole arm and a second dipole arm; a second dipole radiator having a third dipole arm and a fourth dipole arm; and a feed stalk that is configured to electrically connect the first and second dipole radiators to a feed network. The feed stalk includes a first signal trace that is configured to feed first radio frequency (“RF”) signals to the first dipole radiator. The first signal trace connects to the first dipole radiator at a first feed connection. The feed stalk also includes a second signal trace that is configured to feed second RF signals to the second dipole radiator. The second signal trace connects to the second dipole radiator at a second feed connection. A first ground line is connected to the first dipole radiator at a first ground connection and a second ground line is connected to the second dipole radiator at a second ground connection. A first electric field direction of each first RF signal extends across a center point of the dual polarized radiating element when the dual polarized radiating element is viewed from a front of the base station antenna. A second electric field direction of each second RF signal extends across the center point of the dual polarized radiating element when the dual polarized radiating element is viewed from the front. The first electric field direction is orthogonal or substantially orthogonal to the second electric field direction. The feed stalk is offset from the center point of the dual polarized radiating element and does not overlap the center point of the dual polarized radiating element.

The feed stalk can be longitudinally or transversely spaced apart from the center point of the dual polarized radiating element. Longitudinally corresponds to a longitudinal direction of the base station antenna and transversely corresponds to a lateral direction, perpendicular to the longitudinal direction, of the base station antenna

The feed stalk can be provided as a single printed circuit board or a pair of printed circuit boards that extend(s) in a transverse direction and in a front to back direction of the base station antenna. The transverse direction is perpendicular to a longitudinal direction of the base station antenna. The single printed circuit board or the pair of printed circuit boards have a straight orientation between front and rear ends thereof and is/are longitudinally spaced apart from the center point of the dual polarized radiating element, with the front end positioned forward of and adjacent to a printed circuit board providing the first and second dipole radiators.

The feed stalk has a primary body with opposing front and rear ends. The front end can be positioned adjacent the first and second dipole radiators and the primary body can have a segment that angles transversely between the front and rear ends.

The first ground connection can be closer to the center point of the dual polarized radiating element than the first feed connection. The second ground connection can e closer to the center point of the dual polarized radiating element than the second feed connection.

The feed stalk can be a single piece printed circuit board feed stalk that can have only two signal traces, the first and second signal traces, and only two ground lines, the first and second ground lines.

The first and second dipole radiators can be provided by a printed circuit board. The feed stalk can be provided as a first feed stalk and a second feed stalk. The first feed stalk and the second feed stalk can each have a sheet metal body with opposing front and rear end portions. The sheet metal body can have a bend segment closer to the front end portion that bends at an angle of 80-110 degrees with the bend segment behind the printed circuit board.

The bend segment can be a first bend segment that merges into a second bend segment in front of the first bend segment. The second bend segment of the first feed stalk can bend at an angle in a range of 80-110 degrees from the first bend segment to directly define the first ground connection. The second bend segment of the second feed stalk can bend at an angle in a range of 80-110 degrees from the first bend segment to directly define the second ground connection.

The first, second, third and fourth dipole arms can each have a metal pattern on the printed circuit board with respective first, second, third and fourth inner corner regions that comprise a surface area of metal that meet at and extend about the center point of the dual polarized radiating element. The first and second ground connections can reside at an outer perimeter portion of two neighboring corner regions of the first, second, third and fourth corner regions. The first and second feed connections can reside at an inner perimeter portion of a different two of the corner regions.

The feed stalk can be provided as first and second feed stalks, each of the first and second feed stalks can have opposing front and rear end portions. The front end portion of the first feed stalk can be configured to provide the first feed connection at a first orientation and the front end portion of the second feed stalk can be configured to provide the second feed connection at a second orientation that is perpendicular to the first orientation.

The first, second, third and fourth dipole arms can each have a metal pattern on the printed circuit board with respective first, second, third and fourth inner corner regions that comprise a surface area of metal that meet at and extend about the center point of the dual polarized radiating element. The first and second feed connections can reside at an inner perimeter portion of two neighboring corner regions of the first, second, third and fourth corner regions and the first and second ground connections can reside closer to the center point of the dual polarized radiating element adjacent to or on cross-traces connecting the corner regions.

The first dipole radiator and the second dipole radiator can be provided by a printed circuit board and the printed circuit board can have a recess that extends across the center point between the first and second dipole arms or between the second and third dipole arms. The recess can have plated sidewalls.

The recess can have a floor of a dielectric layer of the printed circuit board spanning between the plated sidewalls.

The floor can have a copper layer on a rear surface thereof.

The printed circuit board can have a first a plated through hole and a second plated through hole, both coupled to a copper layer of the feed stalk and configured to electrically connect the first and second dipole arms or the second and third dipole arms. The first and second plated through holes can reside on opposing sides of the recess.

The base station antenna can further include a connection pin coupled to the first and second plated through holes and extending across the recess. The connection pin can have a width that is less than a width of the recess thereby reducing capacitive coupling between the first and second polarizations.

The feed stalk can have a first primary surface that comprises a copper layer and an opposing second primary surface that comprises the first and/or second signal trace and a copper layer. The dual polarized radiating element can have a first solder pad on the first dipole radiator and a second solder pad on the second dipole radiator. The first solder pad can have a first surface that is in front of the dual polarized radiating element and that can be soldered to the first primary surface of the feed stalk and an opposing second surface that is in front of the dual polarized radiating element and that can be soldered to the second primary surface of the feed stalk.

The first plated through hole and the second plated through hole can provide an electrical path to electrically connect to a ground plane provided by one or more copper layers on the feed stalk defining at least part of the first and/or second ground line.

The feed stalk can have a printed circuit board body with a first end portion configured to reside adjacent a reflector or frequency selective surface and an opposing second end portion that is adjacent the first and second dipole radiators. The printed circuit board body can have a portion comprising an angle of inclination between the first and second end portions that can be between 20 and 75 degrees.

The first signal trace and the second signal trace can be provided in a linear trace configuration that is devoid of a balun hook shape and devoid of any rearward turn.

The dual polarized radiating elements can be low band or mid band radiating elements.

The plurality of dual polarized radiating elements can be arranged in linear arrays that reside along right and left side portions of the base station antenna. The base station antenna can also include high band radiating elements can be provided as a multi-column array that reside behind and between the right and left side linear arrays.

The feed stalk can be provided as a pair of cooperating closely spaced apart parallel structures that can provide orthogonal electrical feeds as the first and second RF feed connections to a respective dual radiating element.

The feed stalk can be provided by a pair of cooperating closely spaced apart perpendicular structures that define orthogonal electrical feeds as the first and second RF feed connections to a respective dual radiating element.

The feed stalk can be devoid of an X configuration.

Still other embodiments are directed to a base station antenna that includes a center-fed cross-dipole radiating element having four dipole arms. The center-fed cross-dipole radiating element is configured so that a feed stalk thereof overlaps two of the four dipole arms in the forward direction of the base station antenna but does not overlap the other two of the four dipole arms.

The feed stalk has a forward end portion that can reside in front of the four dipole arms. RF signals in a first electric field direction extend across a first dipole radiator of the center-fed cross-dipole radiating element and RF signals in a second electric field direction extend across a second dipole radiator of the center-fed cross-dipole radiating elements. The first electric field direction can be orthogonal or substantially orthogonal to the second electric field direction.

The four dipole arms can be provided by a dipole arm printed circuit board having a center and the feed stalk can extend through the dipole arm printed circuit board at a location that is offset from the center.

The feed stalk can be devoid of an X-configuration when viewed from a side or a top of the base station antenna.

### BRIEF DESCRIPTION OF THE DRAWINGS

FIG. 1A is a rear perspective view of a multi-band base station antenna.

FIG. 1B is a schematic, front perspective view of the base station antenna of FIG. 1A, with the radome removed.

FIG. 1C is a simplified schematic illustration of the multi-band base station antenna of FIG. 1A.

FIG. 2A is a front, side perspective view of a dual polarized radiating element that has a single feed stalk.

FIG. 2B is a front view of the dual polarized radiating element of FIG. 2A.

FIG. 2C is a front view of another example dual polarized radiating element that has a single feed stalk.

FIG. 3A is a front, side perspective view of a single feed stalk dual polarized radiating element, shown positioned to project forward of a reflector or frequency selective surface, according to the present inventive concept.

FIG. 3B is an enlarged front view of the dual polarized radiating element of FIG. 3A with arrows depicting the +/−polarization E field directions.

FIG. 3C is a graph of simulated isolation data between the two dipole radiators of the dual polarized radiating element of FIG. 3A.

FIG. 4A is a greatly enlarged top view (viewed down from a top of a BSA) of the dual polarized radiating element of FIG. 3A.

FIG. 4B is a greatly enlarged side view of the dual polarized radiating element of FIG. 3A.

FIG. 5A is a front view of the dual polarized radiating element of FIG. 3A.

FIG. 5B is a front, side perspective view of the dual polarized radiating element of FIG. 5A.

FIG. 6 is another front view of the dual polarized radiating element of FIG. 3A that illustrates the plated through holes (PTH) and the metallization on the rear side of the dipole radiator printed circuit board.

FIG. 7 is an enlarged partial front, side view of the dual polarized radiating element of FIG. 3A that illustrates how sidewall electroplating can be added to reduce a size of a coupling area.

FIGS. 8 and 9 are partial front side views of the dual polarized radiating element of FIG. 3A that further illustrate the sidewall electroplating and soldering features.

FIG. 10A is a schematic illustration of a conventional feeding configuration showing a relatively large coupling area.

FIG. 10B is a schematic illustration of the feeding structure contemplated by embodiments of the present invention which can reduce the coupling area providing for improved isolation between polarizations.

FIG. 11A is a front perspective view of a dual polarized radiating element according to further embodiments of the present invention.

FIG. 11B is a schematic rear perspective view of the dual polarized radiating element of FIG. 11A.

FIG. 12 is an enlarged, front perspective view of a center portion of the radiating element of FIG. 11A.

FIG. 13 is an enlarged, schematic rear perspective view of a center portion of the radiating element of FIG. 11A.

FIG. 14 is a front, side perspective view of another example of dual polarized radiating element according to embodiments of the present invention.

FIG. 15 is an enlarged front, perspective, partially transparent, view of the example dual polarized radiating element of FIG. 14.

FIG. 16 is a front view of the dual polarized radiating element of FIG. 15 illustrating the 90 degree intersection of the E-field directions of the +/−45 degree polarizations according to embodiments of the present invention.

FIG. 17A is a front, side perspective view of another dual polarized radiating element according to embodiments of the present invention.

FIGS. 17B and 17C are rear, side perspective views of the dual polarized radiating element of FIG. 17A.

FIG. 18A is a front view of the dual polarized radiating element of FIGS. 17A-17C.

FIGS. 18B and 18C are side views of the dual polarized radiating element of FIG. 18A.

FIG. 19A is a rear, side perspective view of the dual polarized radiating element of FIGS. 17A-17C with the substrate of the dipole radiator arms omitted.

FIG. 19B is an enlarged side perspective view of the feed stalk of FIG. 19A.

FIG. 20A is a front, side perspective view of another dual polarized radiating element according to embodiments of the present invention.

FIG. 20B is an enlarged front, side perspective view of the dual polarized radiating element of FIG. 20A.

FIG. 21A is a front, side perspective view of another dual polarized radiating element according to embodiments of the present invention.

FIG. 21B is an enlarged front, side perspective view of the dual polarized radiating element of FIG. 21A.

FIG. 22A is a front, side perspective view of another dual polarized radiating element according to embodiments of the present invention.

FIG. 22B is an enlarged front, side perspective view of the dual polarized radiating element of FIG. 22A.

FIG. 22C is an enlarged opposing side perspective view of the dual polarized radiating element of FIG. 22B.

FIG. 23A is a front, side perspective view of another dual polarized radiating element according to embodiments of the present invention.

FIG. 23B is an enlarged front, side perspective view of the dual polarized radiating element of FIG. 23A.

FIG. 23C is a side view of the dual polarized radiating element of FIG. 23A-.

### DETAILED DESCRIPTION

Embodiments of the present invention relate generally to radiating elements for multi-band base station antennas and to related base station antennas. The base station antennas that include radiating elements according to embodiments of the present invention may be used, for example, as sector antennas in the above-described cellular communications systems.

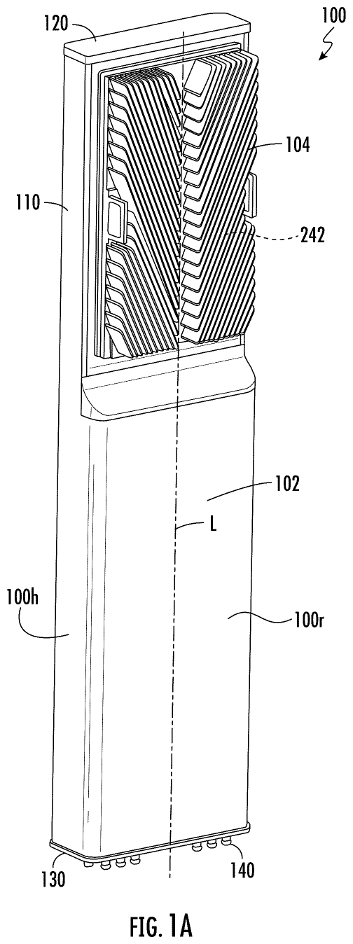

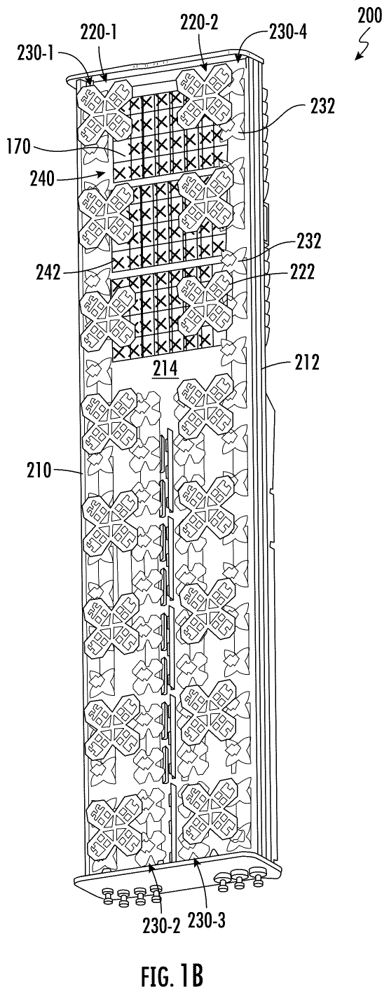

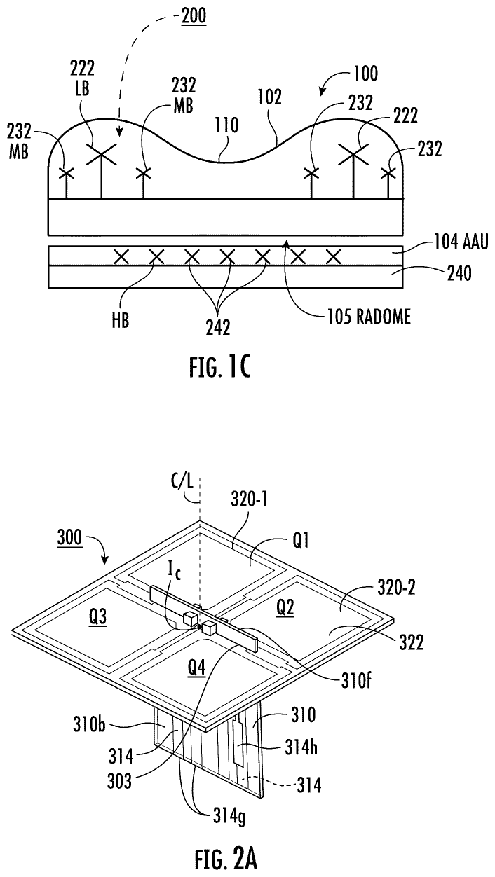

FIGS. 1A-1B illustrate a base station antenna 100 that has arrays of radiating elements that operate in multiple frequency bands. In particular, FIG. 1A is a rear perspective view of the antenna 100, while FIG. 1B is a schematic front view of the antenna 100 with the radome(s) thereof removed to illustrate an antenna assembly 200 of the base station antenna 100. FIG. 1C is a schematic simplified sectional view of the base station antenna 100 of FIG. 1A.

In the description that follows, the base station antenna 100 and the radiating elements included therein will be described using terms that assume that the base station antenna 100 is mounted for use on a support structure such as a tower, with a longitudinal axis L of the base station antenna 100 extending along a vertical axis and the front surface of the base station antenna 100 mounted opposite the tower pointing toward the coverage area for the base station antenna 100.

As shown in FIG. 1A, the base station antenna 100 may comprise, for example, both a passive antenna 102 and an active antenna unit (also described as an active antenna module) 104 that is mounted behind, shown as mounted on, the housing 100h of the passive antenna 102. The passive antenna assembly 200 of passive antenna 102 is mounted within the housing 100h. As shown in FIG. 1B, the passive antenna assembly 200 includes a plurality of arrays of radiating elements that generate static antenna beams that cover predefined regions such as a sector of a cell. The passive antenna 102 may be connected to one or more radios (not shown) such as, for example, remote radio heads that are mounted on the antenna tower adjacent the base station antenna 100. The active antenna unit 104 may, for example, comprise a module that may operate as a standalone antenna or that can be mounted to be behind the rear of the passive antenna 102, behind the base station antenna housing 100h. The active antenna unit 104 may include, for example, radio circuitry and a multi-column beamforming array of radiating elements. The active antenna unit 104 may generate antenna beams that can be dynamically steered throughout a coverage area (e.g., a sector) and which can have narrow azimuth beamwidths and high antenna gain. Examples of base station antennas that include both a passive antenna 102 and an active antenna unit 104 that is mounted behind the passive antenna 102 are described, for example, in U.S. Patent Publication No. 2021/0305717 (“the '717 publication”), filed Mar. 23, 2021, the entire content of which is incorporated herein by reference. It will be appreciated that any of the radiating elements according to embodiments of the present invention disclosed herein may be used to form the low-band and/or mid-band arrays in the various base station antennas disclosed in the '717 publication.

Still referring to FIG. 1A, the passive antenna 102 is an elongated structure that extends along the longitudinal axis L. The passive antenna 102 may have a generally rectangular cross-section. The passive antenna 102 can include a radome 110 and a top end cap 120. The passive antenna 102 also includes a bottom end cap 130 which includes a plurality of connectors 140 such as RF ports mounted therein. The passive antenna 102 is typically mounted in a vertical configuration (i.e., the longitudinal axis L may be generally perpendicular to a plane defined by the horizon) when the passive antenna 102 is mounted for normal operation. The radome 110, top cap 120 and bottom cap 130 may form the protective housing 100h for the antenna assembly 200 of the passive antenna 102. The antenna assembly 200 (FIG. 1B) for the passive base station antenna 102 is contained within the housing 100h.

The active antenna unit 104 can be mounted on the rear of the passive base station antenna housing 100h. The active antenna unit 104 may include a multi-column array of radiating elements 240 that is mounted behind a radome 105 (FIG. 1C) of the active antenna unit 104. As described in the '717 publication, the multi-column array of radiating elements 240 may transmit and receive RF signals through the passive antenna 102. A reflector of the passive antenna 102 may include an opening aligned with the active antenna unit 104. A frequency selective surface 170 (FIG. 1C, 3A) may be mounted in, in front of or behind the opening. The frequency selective surface 170 will appear as an opening to RF energy in the operating frequency band of the multi-column array, allowing the RF energy of the multi-column array 240 (FIGS. 1B, 1C) to transmit therethrough, unblocked, while reflecting RF energy in the operating frequency bands of at least some of the arrays in the passive antenna 102.

Referring to FIG. 1B, the passive antenna assembly 200 includes a ground plane structure 210 that has sidewalls 212 and a primary reflector surface 214. Various mechanical and electronic components of the passive antenna 102 (not shown) may be mounted in a chamber that is defined between the sidewalls 212 and the back side of the reflector surface 214 such as, for example, phase shifters, remote electronic tilt units, mechanical linkages, controllers, diplexers, and the like. The reflector surface 214 of the ground plane structure 210 may comprise or include a metallic surface (e.g., a sheet of aluminium) that serves as a reflector and ground plane for the radiating elements of the antenna 100. Herein, the (primary) reflector surface 214 may also be referred to as the (primary) reflector 214.

The passive antenna assembly 200 includes a plurality of dual-polarized radiating elements that are mounted to extend forwardly of the frequency selective surface (FSS) 170 and/or the reflector 214. The radiating elements include low-band radiating elements 222 and mid-band radiating elements 232. The low-band radiating elements 222 can be mounted in two columns to form two linear arrays 220-1, 220-2 of low-band radiating elements 222. The low-band radiating elements 222 may be configured to transmit and receive signals in a first frequency band. In some embodiments, the first frequency band may comprise the 617-960 MHz frequency range or a portion thereof (e.g., the 617-896 MHz frequency band, the 696-960 MHz frequency band, etc.). The mid-band radiating elements 232 can be mounted in four columns to form four linear arrays 230-1 through 230-4 of mid-band radiating elements 232. The mid-band radiating elements 232 may be configured to transmit and receive signals in a second frequency band. In some embodiments, the second frequency band may comprise the 1427-2690 MHz frequency range or a portion thereof (e.g., the 1710-2200 MHz frequency band, the 2300-2690 MHz frequency band, etc.). Herein, the linear arrays 220-1, 220-2 of low-band radiating elements 222 may also be referred to as the low-band linear arrays 220-1, 220-2, and the linear arrays 230-1 through 230-4 of mid-band radiating elements 232 may also be referred to as the mid-band linear arrays 230-1 through 230-4. It should be noted that herein like elements may be referred to individually by their full reference numeral (e.g., linear array 230-2) and may be referred to collectively by the first part of their reference numeral (e.g., the linear arrays 230).

As discussed above, the active antenna module 104 includes a multi-column array of high-band radiating elements 242. This array of high-band radiating elements 242 may be referred to herein as a high-band array 240. In FIG. 1B, the high band array 240 is visible in the figure, since the radome 105 of the active antenna module 104 is omitted from the figure. The high-band radiating elements 242 may be configured to transmit and receive signals in a third frequency band. In some embodiments, the third frequency band may comprise the 3300-4200 MHz frequency range or a portion thereof. As discussed above, the high-band array 240 may be a beamforming array that in conjunction with the beamforming radio in the active antenna module 104 can generate antenna beams that can be dynamically shaped and steered across a coverage area.

As shown in FIG. 1C, the high band array 240 can be provided in the active antenna module 104 which can be provided as a separate and external housing with a radome 105 that resides behind the housing 102 of the passive antenna 200.

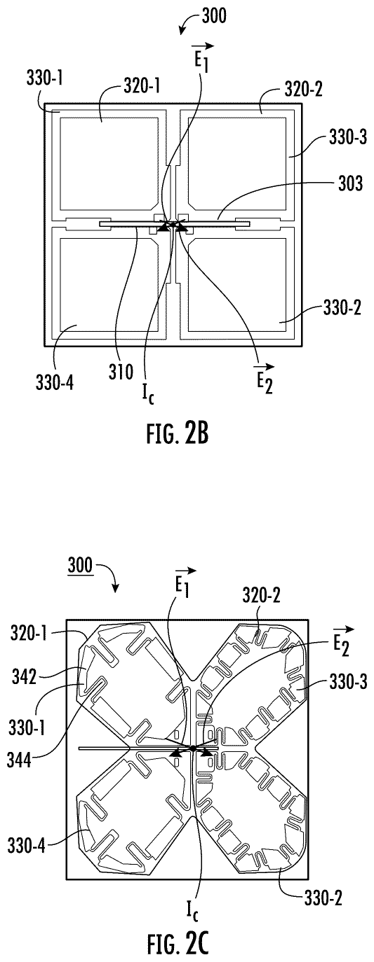

FIGS. 2A-2C illustrate an example dual polarized radiating element 300 that can correspond to the low-band radiating elements 222 and/or the mid-band radiating elements 232 of the base station antenna 100.

The dual polarized radiating element 300 includes a feed stalk 310 that comprises a single piece body 310b that can attach to and first and second dipole radiators 320-1, 320-2. The feed stalk 310 may be implemented as single printed circuit board in example embodiments. The first dipole radiator 320-1 extends along a first axis and the second dipole radiator 320-2 extends along a second axis that is generally perpendicular to the first axis. Consequently, the first and second dipole radiators 320-1, 320-2 are arranged in the general shape of a cross. The first dipole radiator 320-1 includes first and second dipole arms 330-1, 330-2, and the second dipole radiator 320-2 includes third and fourth dipole arms 330-3, 330-4. The first and second dipole radiators 320-1, 320-2 can be formed on a dipole radiator printed circuit board 322 in the depicted embodiment. Each dipole arm 330 can reside in a different quadrant Q1-Q4 of the printed circuit board 322.

The feed stalk 310 can have two RF feed lines 314 formed thereon. Each RF feed line 314 is designed to pass RF signals between a feed board printed circuit board (not shown) and a respective one of the dipole radiators 320-1, 320-2. Each RF feed line 314 comprises a hook balun 314h and a pair of ground lines 314g. The feed stalk 310 is a printed circuit board oriented to define a vertically extending column (in the orientation shown) that, in use, extends in a front to back direction of the base station antenna 100.

The hook balun 314h of each RF feed line 314 can be connected to a corresponding signal conductor of an RF transmission line (not shown), such as a center conductor of a coaxial cable or a signal trace of a microstrip transmission line on a feed board printed circuit board. Each pair of ground lines 314g can be connected to a ground conductor of the RF transmission line.

The dual polarized radiating element 300 has a center Ic that is centered on the printed circuit board 322 and positioned between the four quadrants Q1-Q4. In other words, the center Ic is at the location where the four dipole radiator arms 330-1, 330-2, 330-3, 330-4 come together when the radiating element 300 is viewed from the front. As shown, a slot 303 extends transversely in between dipole radiator arms 330-1 and 330-4 and in between dipole radiator arms 330-2 and 330-3. The slot 303 intersects the longitudinally extending centerline C/L of the feed stalk 310 and a front portion 310f of the printed circuit board forming the feed stalk 310 extends through the slot 303 to reside forward of the printed circuit board 322 forming the dipole radiators 320-1, 320-2.

Dipole arms 330-1 and 330-2 of first dipole radiator 320-1 are center fed by a first of the RF transmission lines 314 and radiate together at a first polarization. In the depicted embodiment, the first dipole radiator 320-1 is designed to transmit signals having a slant +45° linear polarization. Dipole arms 330-3 and 330-4 of second dipole radiator 320-2 are center fed by the second of the RF transmission lines 314 and radiate together at a second polarization that is orthogonal to the first polarization. The second dipole radiator 320-2 is designed to transmit signals having a slant −45° linear polarization. The radiating element 300 is thus referred to as a “cross-dipole” radiating element.

A challenge in the design of multi-band base station antennas is reducing the effect of scattering of the RF signals at one frequency band by the radiating elements of other frequency bands. Scattering is undesirable as it may affect the shape of the antenna beam in both the azimuth and elevation planes, and the effects may vary significantly with frequency, which may make it hard to compensate for these effects. Moreover, at least in the azimuth plane, scattering tends to impact the beamwidth, beam shape, pointing angle, gain and front-to-back ratio of the antenna beams in undesirable ways.

As shown in FIGS. 2B, 2C, each dipole arm 330 may comprise a shaped metal pattern on the dielectric substrate of the dipole radiator printed circuit board 322. As shown in FIG. 2C, the metal pattern forming each dipole arm 330 can include a plurality of widened sections 342 that are connected by narrowed trace sections 344. This design allows the dipole arms 330 to act as “cloaking” dipole arms that have reduced impact on the antenna beams generated by closely located radiating elements that transmit and receive signals in other frequency bands (i.e., reduced scattering). This ensures that the radiating element 300 will not substantially impact the radiation pattern of other radiating elements of antenna 100 that are mounted near radiating element 300. Dipole arms 330-1 and 330-3 may be located near (e.g., directly in front of) mid-band radiating elements 232 of antenna 100, and hence have metal patterns that are designed to be substantially transparent to RF energy in the mid-band operating frequency band. Dipole arms 330-2 and 330-4 may be located near (e.g., directly in front of) high-band radiating elements 242 of antenna 100, and hence have metal patterns that are designed to be substantially transparent to RF energy in the high-band operating frequency band.

The dual polarized radiating element 300 can have a one-piece feed stalk 310 that is easy to integrate, does not substantially scatter RF radiation emitted by the multi-column array 240 and can reduce costs over conventional larger multiple-piece feed stalks. However, as shown by the arrows in FIGS. 2B and 2C, the feed stalk 310 couples to the dipole radiators 320-1, 320-2 in a manner so that the electric fields of the RF signals that feed the dipole radiators 320-1, 320-2 are non-orthogonal. As shown, the electric fields can intersect at an angle that is close to 30-45°,as shown by the arrows E₁ and E₂ that correspond to the electric fields. This may result in reduced or poor isolation.

Generally stated, the present inventive concept provides radiating elements having feed stalks that have low scattering while also connecting with the dipole radiators so that the electric fields of the RF feed signals have orthogonal or substantially orthogonal electric field directions. The term “substantially orthogonal” with respect to these electric fields means that they intersect at an angle that is within +/−10% of orthogonal. The intersection can be at the center of the printed circuit board providing the four dipole arms.

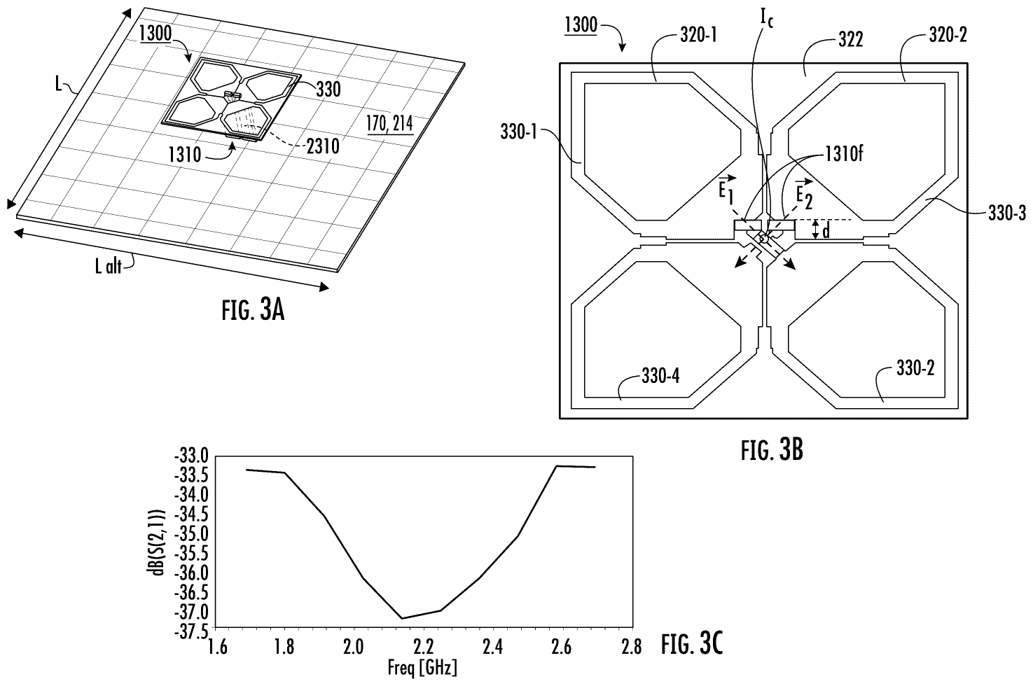

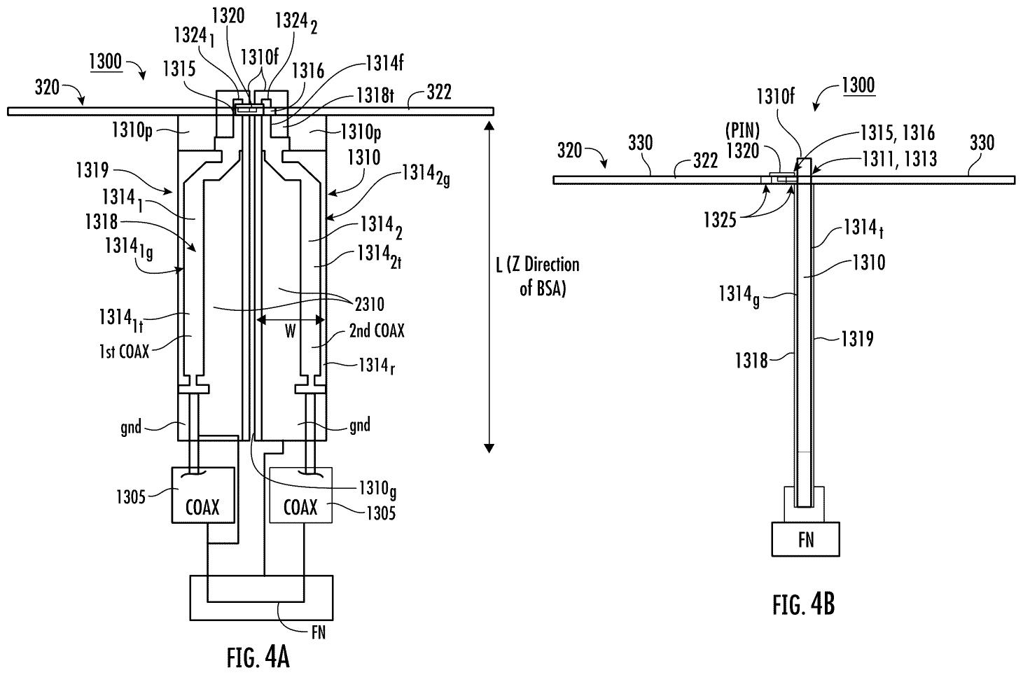

Referring to FIGS. 3A, 3B, 4A and 4B, a dual polarized radiating element 1300 according to embodiments of the present invention is shown which provides electric fields that intersect at the center Ic at an orthogonal or substantially orthogonal angle as shown by the arrows for the electric field vectors E₁, E₂ corresponding to the +/−45 degree polarizations. The dual polarized radiating element 1300 can be used to implement the low-band radiating elements 222 and/or the mid-band radiating elements 232 of the base station antenna 100 such as, but not limited to, the base station antenna 100 shown in FIGS. 1A-1C.

The feed stalk 1310 of the dual radiating element 1300 comprises first and second RF feed lines 1314₁, 1314². The first RF feed line 1314₁ comprises a first signal trace 1314₁ₜ (which can also be referred to as an “RF trace”, “signal feed” or “signal transmission trace”) and a first ground line 1314_{1g}. The second RF feed line 1314₂ comprises a second signal trace 1314₂ₜ and a second ground line 1314_{2g}. The first RF feed line 1314₁ may be referred to as a first polarized RF line (e.g., +45 degrees) as it feeds a dipole radiator 320-1 having a first polarization from a first RF transmission line 1305 and the second RF feed line 1314₂ may be referred to as a second polarized RF feed line (e.g.,−45 degrees) as it feeds a dipole radiator 320-2 having a second polarization from a second RF transmission line 1305. The RF transmission lines 1305 can be, for example, microstrip transmission lines on feed boards or coaxial cables or other cables that terminate directly into the feed stalks. To simplify the drawings, the RF transmission line elements 1305 are shown as blocks in the figures to emphasize that any appropriate RF transmission line structure may be used.

FIG. 3C is a graph of simulated cross polarization isolation (in dB) versus frequency for the radiating element 1300 of FIGS. 3A-3B, 4A-4B. As shown in FIG. 3C, the cross-polarization isolation is below −30.5 dB throughout the entire mid-band frequency range (1.7-2.7 GHz), which is about 10 dB better than the radiating elements of FIGS. 2A-2C.

Referring to FIG. 3A, the radiating element 1300 can be mounted to extend forward of the FSS 170 or reflector 214. The feed stalk 1310 can be oriented so that the primary surface 2310 extends in the longitudinal direction L of the base station antenna 100 (FIG. 1A). However, in other embodiments, the feed stalk 1310 can be oriented so that the primary surface extends laterally, in a direction perpendicular to the longitudinal direction of the base station antenna with the FSS or reflector, 170, 214, rotated 90 degrees to Lalt from the orientation shown in FIG. 3A when mounted in the base station antenna 100.

Referring to FIGS. 4A and 4B, in some embodiments, the feed stalk 1310 extends in the transverse direction of the dipole radiator printed circuit board 322 so that when the beams from a high-band array antenna 1195 are scanned in a horizontal plane they only see the side edges of the feed stalks 1310, and hence very little scattering by the feed stalks on the high-band radiation. In this embodiment, when the BSA 100 is viewed from the top (FIG. 1A) down, the orientation shown in FIG. 4A is seen, providing a “top view” of the radiating element 1300. When looking at the feed stalk 1310 shown in FIG. 4A outside the base station antenna 100, this view can also be described as a “front view” outside of the base station antenna with the primary surface 2310 comprising the signal trace 1314t side being a front and a ground line 1314g side being the back, with the edge or thickness being the side.

As shown in FIG. 4A, the first and second RF feed lines 1314₁, 1314₂ do not have hook baluns and hence comprise a respective single signal trace 1314₁ₜ and a respective single ground line 1314_{1g}, that extend between the input location connecting to RF transmission line element 1305 and output location to connect to a respective dipole radiator 320. The signal traces 1314t can be provided on one (e.g., a front) primary surface 2310 and the ground lines 1314g can be provided on the opposing (e.g., rear) primary surface 2310. This design requires less room on a feed stalk printed circuit board and hence the radiating element 1300 may have a smaller feed stalk printed circuit board that is less expensive, and which will cause less scattering of high-band RF signals. The first and second RF feed lines 1314₁, 1314₂ can comprise respective microstrip transmission lines on a printed circuit board that each connect to a respective RF transmission line 1305 at an input location and that extend to connect to first and second dipole radiators 320-1, 320-2 at the front end portion 1310f of the feed stalk 1310.

The feed stalk 1310 can have a first metal layer 1318 that connects to the signal conductor of the RF transmission line 1305 and a second metal layer 1319 that can connect to the ground conductor of the RF transmission line 1305 for providing a ground input. The feed stalk 1310 can connect to a feed network FN as is well known to those of skill in the art. The feed stalk 1310 can reside in front of the primary reflector 214 or a frequency selective surface 170 (FIG. 3A).

The first metal layer 1318 can extend across 70-100 percent of a lateral extent (W) over a majority of a length (L) of the feed stalk structure 1310p (where the length extends in the front-to-back direction). The first metal layer 1318 may simply comprise the signal traces 1314₁ₜ, 1314₂ₜ of the first and second RF feed lines 1314₁, 1314₂. The first and second RF feed lines 1314₁, 1314₂ may narrow adjacent the dipole radiator printed circuit board 322, and may extend laterally forward beyond the dipole radiator printed circuit board 322. The signal traces 1314₁ₜ, 1314₂ₜ can travel laterally inward to position the front ends 1314f of the signal traces 1314₁ₜ, 1314₂ₜ are closer together than the rear ends 1314r. The second metal layer 1318 can extend across 90-100 percent of a lateral extent (W) over a majority of a length (L) of the feed stalk structure 1310p. The second metal layer 1318 may simply comprise the ground lines 1314_{1g}, 1314_{2g} of the first and second RF feed lines 1314₁, 1314₂.

As shown in FIG. 4A, for example, the feed stalk 1310 can position the front end portion 1310f forward of the printed circuit board 322 forming the dipole radiators 320-1, 320-2. The front end portion 1310f provides spaced apart connection surfaces for electrically connecting to, e.g., for solder attachment, different dipole arms 330. The front end portion 1310f of the feed stalk 1310 can be offset in a front to back or left to right direction a distance “d” from the center point Ic. The feed stalk 1310 can be provided by two structures, such as two printed circuit board structures 1310p, as shown, or alternatively can be a single printed circuit board. The two printed circuit board structures 1310p can be parallel and closely spaced apart with a gap 1310g extending at least part of a length dimension L thereof. As shown, the gap 1310g extends the entire length dimension L.

The feed stalk 1310 whether provided by a single printed circuit board or pairs of printed circuit boards or pairs of other structures (FIGS. 14, 20A, 21A. 22A, 23A) is devoid of an X configuration which conventionally extended across the center Ic of the dipole radiator printed circuit board 322.

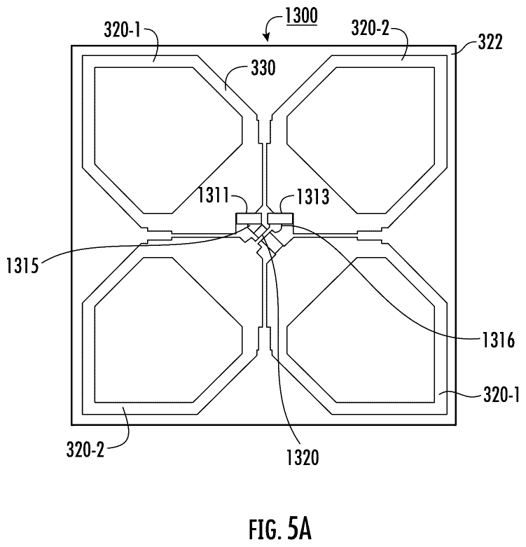

Referring to FIG. 5A, the front end portion 1310f can provide a first connection 1311 at a first location to galvanically connect the first ground line 1314_{1g} to the first dipole arm 330-1 and a second connection 1313 at a second location to galvanically connect the second ground line 1314_{2g} to the third dipole arm 330-3. The front end portion 1310f can include a third connection 1315 opposite the first connection 1311 that galvanically connects the first signal trace 1314₁ₜ to the second dipole arm 330-2 and a fourth connection 1316 opposite the second connection 1313 that galvanically connects the second signal trace 1314₂ₜ to the fourth dipole arm 330-4. The first and second connections 1311, 1313, respectively, can be electrically coupled, e.g., soldered to the second metal layer 1319 via a corresponding solder joint/pad. The third and fourth connections 1315, 1316, respectively, can be soldered to the first metal layer 1318 via a corresponding solder joint/pad.

The first RF feed line 1314₁ is configured to feed RF signals to the first dipole radiator 320-1. The first signal trace 1314₁ₜ connects to the first dipole radiator 320-1 at a first feed connection 1324₁ (FIG. 4A). The second RF feed line 1314₂ is configured to feed RF signals to the second dipole radiator 320-2. The second signal trace 1314₂ₜ connects to the second dipole radiator 320-2 at a second feed connection 1324₂ (FIG. 4A). The first ground line 13141g is connected to the first dipole radiator 320-1 at a first ground connection 1311 and the second ground line 1314_{2g} is connected to the second dipole radiator 320-2 at a second ground connection 1313. The first and second dipole arms 330-1, 330-2 of the first dipole radiator 320-1 cooperate with the feed stalk 1310 to generate a first polarization signal with a first electric field direction extending across a center point Ic of the dual polarized radiating element 1300. The third and fourth dipole arms 330-3, 330-4 of the second dipole radiator 320-2 cooperate with the feed stalk 1310 to generate a second polarization signal with a second electric field direction extending across the center point Ic of the dual polarized radiating element 1300 so that the first electric field direction is orthogonal (or substantially orthogonal) to the second electric field direction

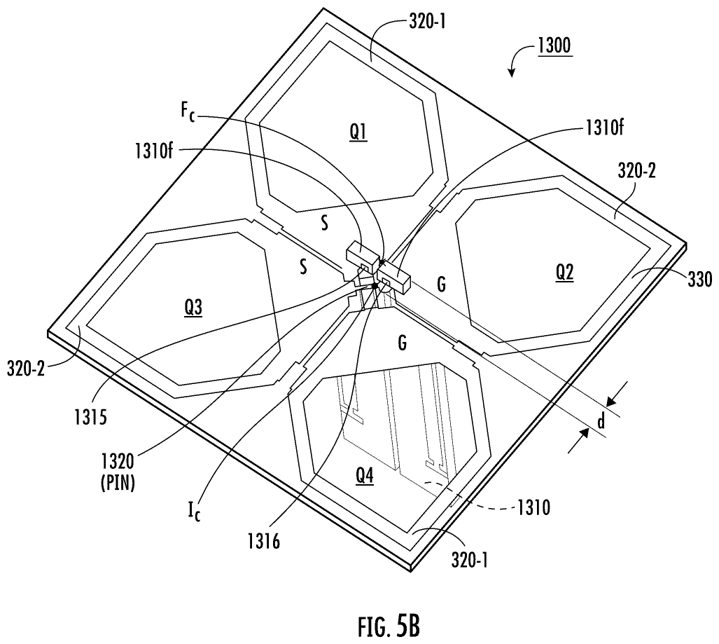

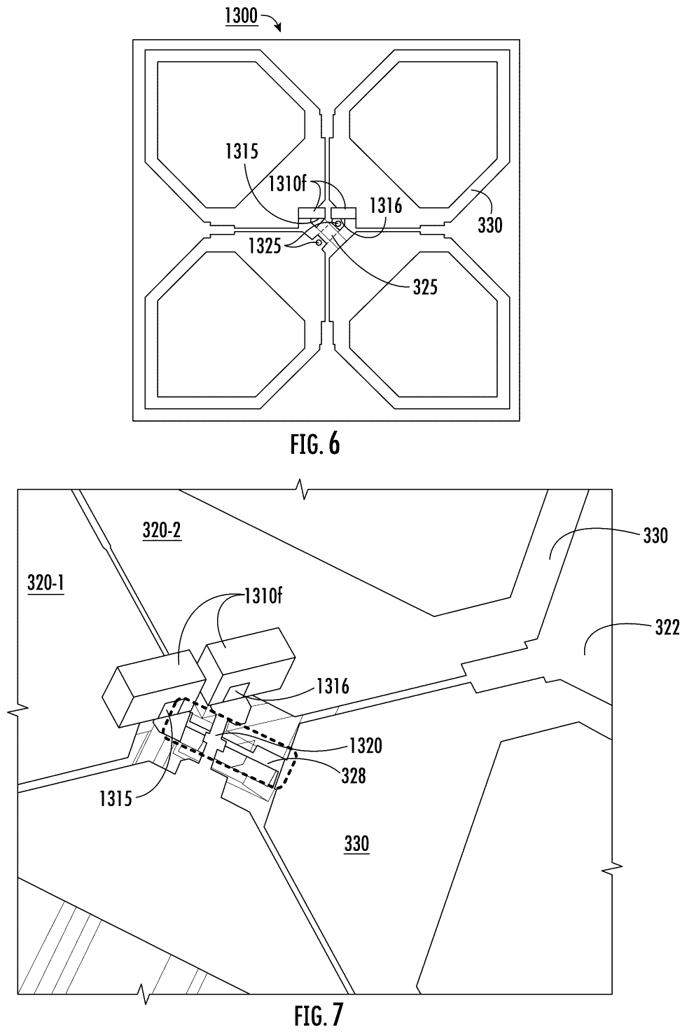

Referring to FIGS. 5A, 5B, a small trace 1320 on the front side of the dipole radiator printed circuit board 322 extends between the feed stalk 1310 and the fourth dipole arm 330-4, thereby electrically connecting the second signal trace 1314₂ₜ to the fourth dipole arm 330-4. Another small trace 325 (not visible in FIG. 5A, but sec FIGS. 6, 11B and 13) is provided on the rear side of the dipole radiator printed circuit board 322 and extends between the feed stalk and the second dipole arm 330-2, thereby electrically connecting the first signal trace 1314₁ₜ to the second dipole arm 330-2. As shown in FIGS. 6, 11A, 11B and 13, plated through holes 1325 can be used to connect to the small trace 325 on the rear side of the dipole radiator printed circuit board 322. The traces 1320 and 325 “crossover” each other without being electrically connected by the implementing the two traces on different metals layers of the dipole radiator printed circuit board 322 and by using the plated through holes 1325 to connect to the trace 325. FIG. 5B shows an example arrangement of the quadrants Q1-Q4 of the dipole radiators 320-1, 320-2 and corresponding ground (G) and signal (S) connection areas/points and paths forming the electric fields that intersect at (substantially) 90 degrees across the center Ic of the printed circuit board 322.

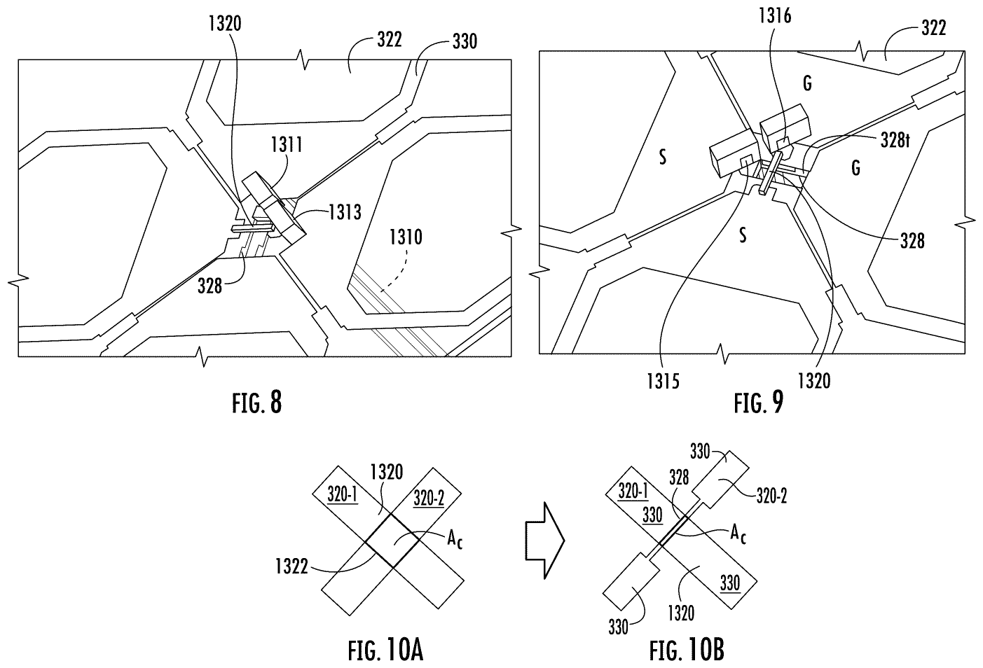

The feed stalk 1310 can be configured to be offset from the center Ic of the printed circuit board 322 providing the dipole arms 330. The feed stalk 1210 can extend through the dipole radiator printed circuit board 322. Compare, for example, FIG. 2B with FIGS. 5B and 8. The offset “d” from the center Ic can be such that the feed stalk 1310 overlaps only two of the four dipole arms 330 whether the feed stalk 1310 terminate behind the dipole radiator printed circuit board 322 or extends through and forward thereof.

The feed stalk 1310 can be defined by a single printed circuit board (FIGS. 3A, 11A, 23A) or by a pair of feed stalk structures 1310s that do not have an X or cross-over configuration (FIGS. 14, 20A, 21A, 22A). Thus, the feed stalk 1310, 1310s does not overlap the center point Ic of the dual radiating element 1300 (viewed from the front of the base station antenna or in the forward direction).

Referring to FIG. 5B, the radiating element can be a center-fed cross-dipole radiating element with the feed stalk 1310 arranged to overlap only two of the dipole arms 330 in the forward direction but does not overlap the other two dipole arms 330. The center Fe of the feed stalk 1310 does not overlap the center Ic of the dipole radiator printed circuit board 322.

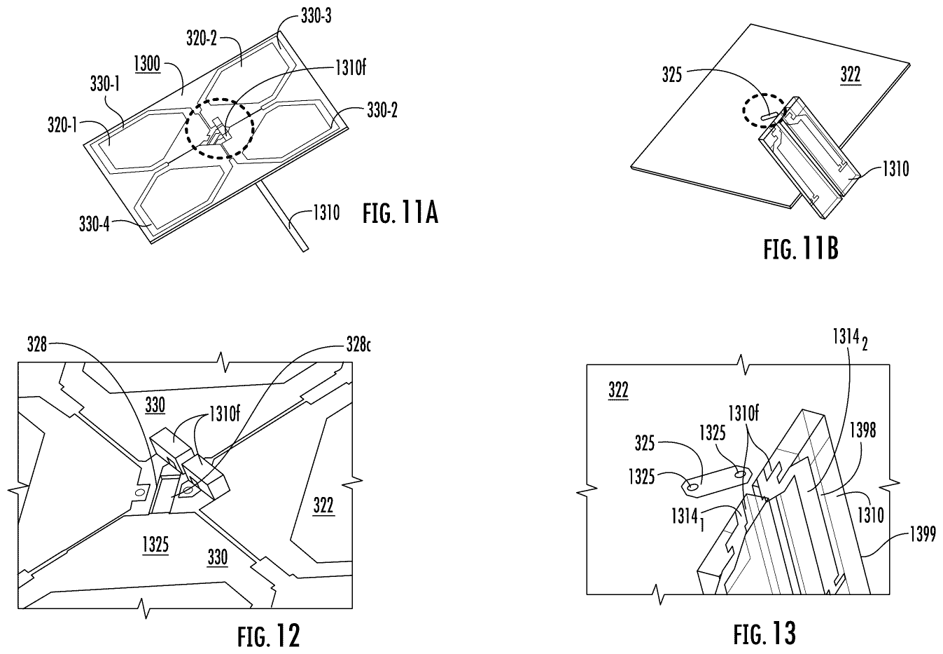

Referring to FIGS. 7, 8, 10A and 10B, in some embodiments, metal may be electroplated on sidewalls 328 of the portions of the dielectric substrate of the dipole radiator printed circuit board 322 to reduce a coupling area, between the cross-over segment of the respective intersecting electric fields. The electroplated sidewalls 328 can be provided in the printed circuit board 325 as sidewalls 328 of a square or rectangular recess with a closed bottom 328c (FIG. 12) or as sidewalls 328 of a square or rectangular open through slot 328t (FIG. 9).

In the past, a wide trace 1322 with a cross-pin 1320 was used to feed the respective dipole radiator 320-1, 320-2 (FIG. 10A), but a wide trace 1322 can cause a large coupling area Ac providing an undesired stronger coupling. Embodiments of the present invention can reduce the coupling area Ac as shown schematically in FIG. 10B. As the thickness of the trace is only about 0.035 mm, the trace connects a respective signal 1314t or ground line 1314g on the feed stalk 1310 to a corresponding dipole arm and can be provided by the sidewalls 328 which rotates the trace to be oriented in a front to back direction instead of across the front surface of the dipole radiators 320 to reduce the coupling area Ac while retaining the same width of the wide trace which can reduce the coupling and keep the wide feed size. The electroplated sidewalls 328 can have an electrical plating thickness that is about the same as the thickness of the trace, e.g., be about 0.035 mm.

The trace 1322 and the cross pin 1320 can replace a conventional wider trace on the dipole radiator PCB with a metal pin/rod that is soldered to the dipole radiator PCB 322 which can allow a thicker but narrow pin/rod instead of a wider trace which can help better align the electric fields to be orthogonal.

FIG. 12 shows the depth of the slot 328c is a partial depth in the substrate of the printed circuit board 322, such as about half the thickness of the printed circuit board 322 providing the dipole arms 330.

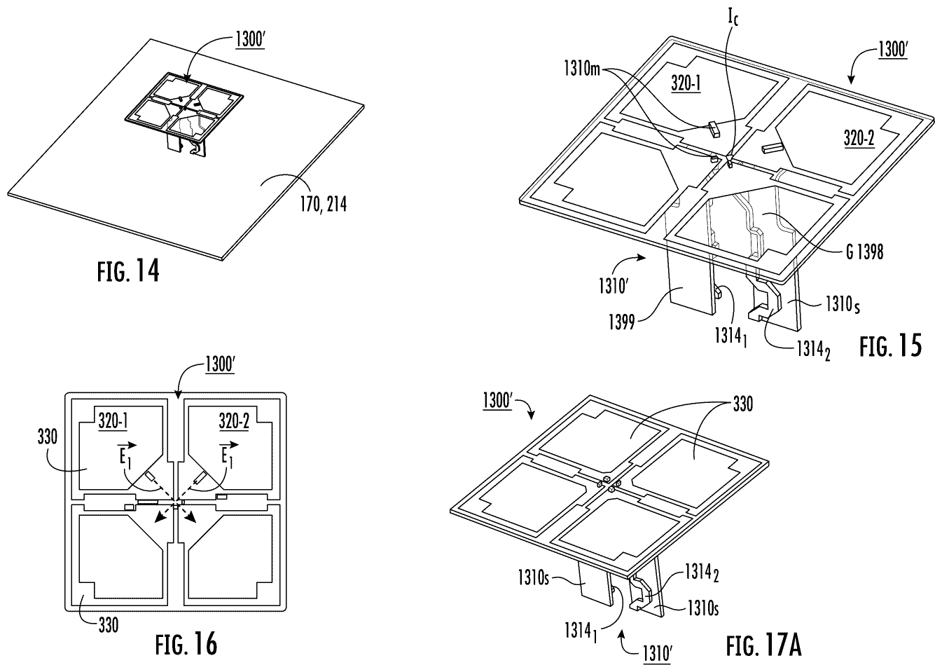

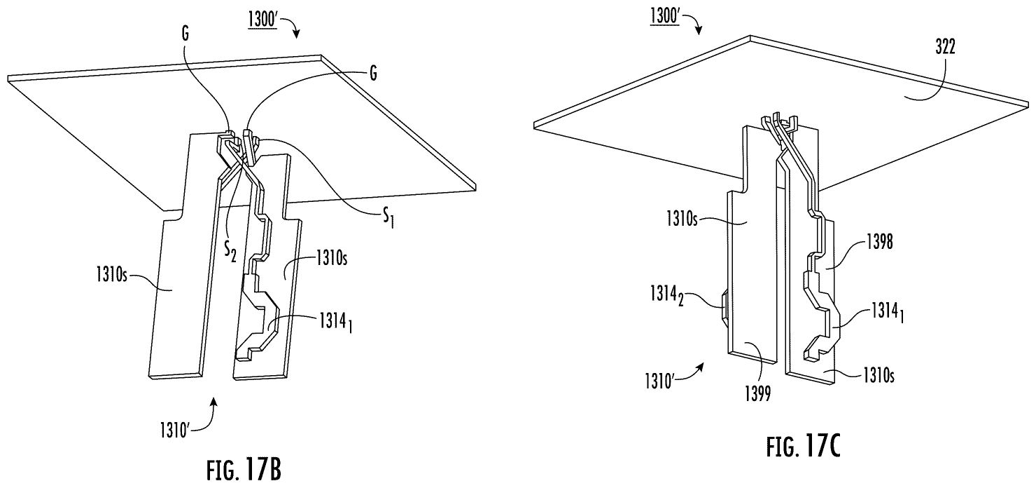

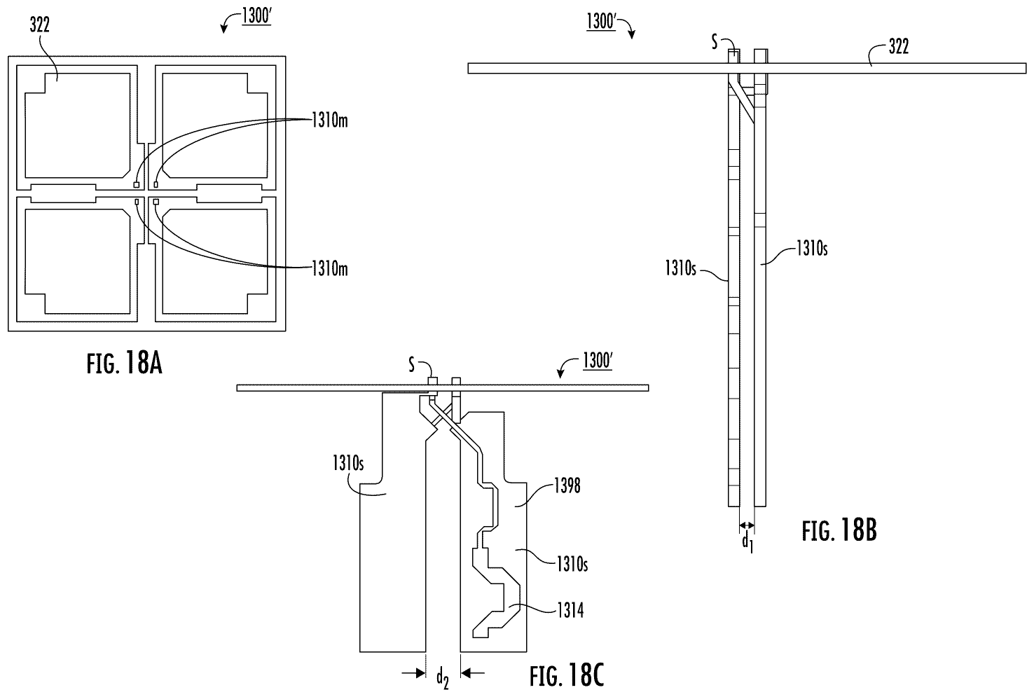

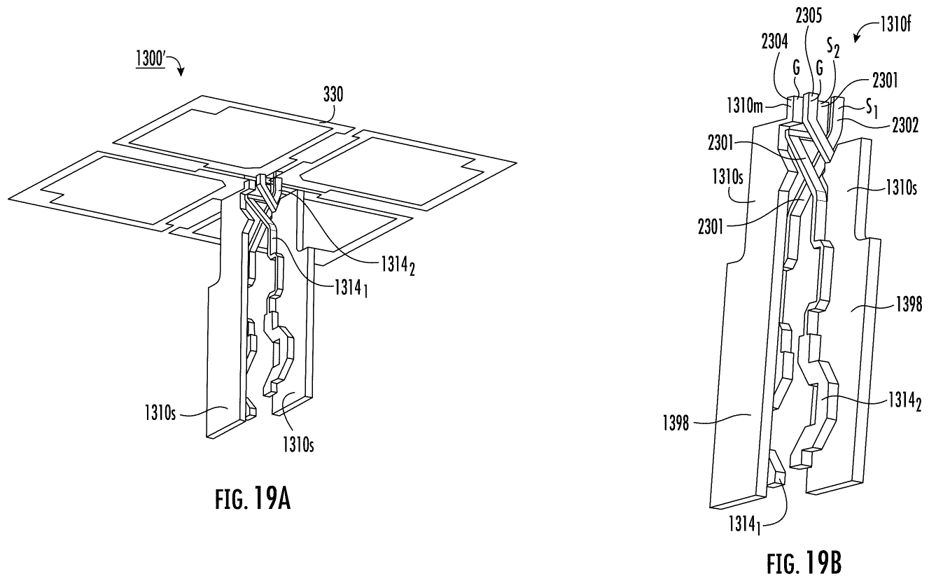

Turning now to FIGS. 14-16, 17A-17C, 18A-18C, 19A and 19B, another embodiment of a dual radiating element 300′ is shown. In this embodiment, the feed stalk 1310′ is provided by a pair of sheet metal bodies 1310s. Each sheet metal body 1310s can be bent into to first and second connected metal segments 1310m to provide a respective feed point directly at a position where the +/−45 degree polarization electric fields are orthogonal to each other. Each sheet metal body 1310s can provide an RF feed line 1314₁, 1314₂. Each RF feed line 1314 includes a first metal segment 1310m that forms the signal trace and a second metal segment 1310m that forms the ground line. The metal segments 1310m forming the signal traces can be closer to the center Ic of the dipole radiators 320 between the dipole arms 330 than the metal segments 1310m forming the ground lines. One or more of the metal segments 1310m can be bent to have a segment 2301 that angles laterally inward and then projects forward in a straight segment 2302 to form a suitable RF connection to the dipole arms 330 of respective dipole radiator 320. Other metal segments 1310m can have other shapes to project forward for ground G connections, such as a third metal segment 1310 which has a forward projecting first prong 2304 and a fourth metal segment 1310m that angles inward, then forward to a second prong 2305 to be in line with the first prong 2304.

The sheet metal bodies 1310s can be first and second sheet metal bodies 1310s that are parallel and project forward but are spaced apart in an X direction (lateral dimension) a distance d2 and offset or spaced apart in a Y direction (longitudinal dimension) a distance d1 where d1 can be greater than d2.

The metal segments 1310m can be provided as four metal segments each of which that can directly connect to four locations of metal surfaces of different dipole arms 330.

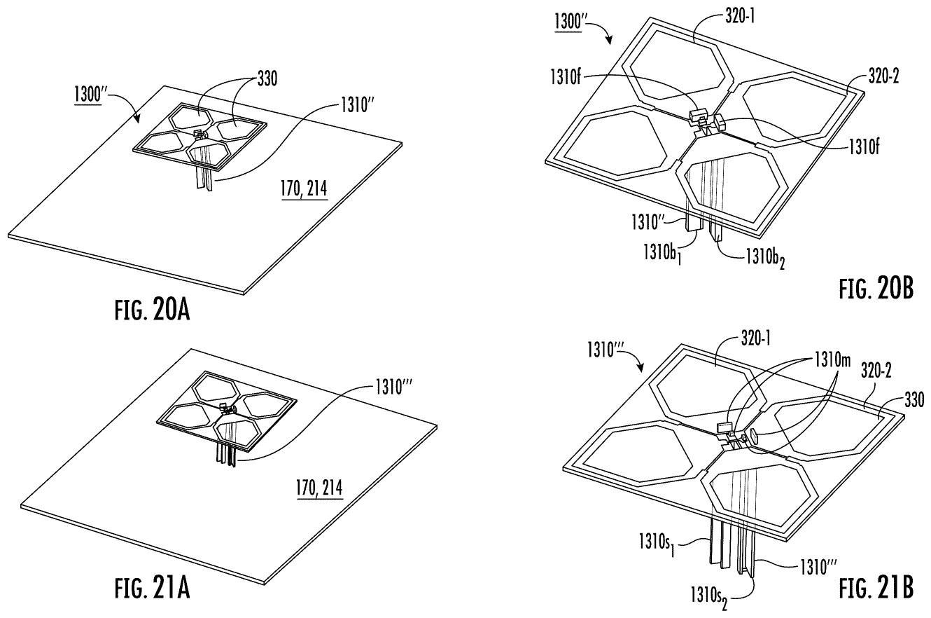

Turning now to FIGS. 20A and 20B, the dual radiating element 1300″ can have a feed stalk 1310″ provided as a pair of feed stalk printed circuit boards that are positioned to define an angle of 90° therebetween but that are spaced apart and do not cross each other, providing the orthogonal electric fields discussed above with respect to FIGS. 3A-3C. One feed stalk 1310b₁ is under one dipole arm 330 of the first dipole radiator 320-1 and one feed stalk 1310b₂ is under one dipole arm 330 of the second dipole radiator 320-2, both feed stalks 1310b₁, 1310b₂ provide front ends 1310f that are orthogonal and offset from the center Ic of the printed circuit board 322 and on the same lateral or same longitudinal side.

Turning now to FIGS. 21A and 21B, the dual radiating element 1300′″ can have a feed stalk 1310″ provided as a pair of sheet metal stalks 1310s1, 1310s2 that are spaced apart and do not cross each other, providing the orthogonal electric fields discussed above with respect to FIGS. 3A-3C. One feed stalk 1310s1 is under one dipole arm 330 of the first dipole radiator 320-1 and one feed stalk 1310s2 is under one dipole arm 330 of the second dipole radiator 320-2, both feed stalks 1310s1, 1310s2 provide front ends 1310f that are orthogonal and offset from the center Ic of the printed circuit board 322 and on the same lateral or same longitudinal side.

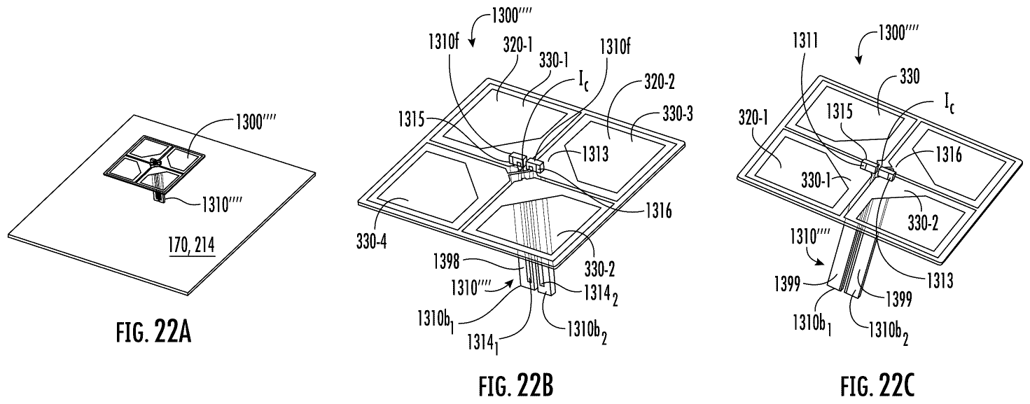

Turning now to FIGS. 22A-22C, the dual radiating element 1300″″ can have a feed stalk 1310″″ provided as a pair of printed circuit boards that are parallel, similar to the embodiment of FIG. 3A, providing the orthogonal electric fields discussed above with respect to FIGS. 3A-3C. In this embodiment, one dipole arm 330 can be soldered to one feed stalk 1310b1 on both sides at connections 1313, 1316 and one dipole arm 330 can be soldered to the other feed stalk 1310b2 at both sides at connections 1311, 1315. One feed stalk 1310b1 is under one dipole arm 330 of the first dipole radiator 320-1 and one feed stalk 1310b2 is under one dipole arm 330 of the second dipole radiator 320-2, both feed stalks 1310b1, 1310b2 provide front ends 1310f that are offset from the center Ic of the printed circuit board 322 and on the same lateral or same longitudinal side. The double soldering can increase stability for mechanical support. The signal trace/feed can be soldered to one side of the dipole arm/feed stalk and a ground feed can be soldered at both sides of the dipole arm/feed stalk body 1310b.

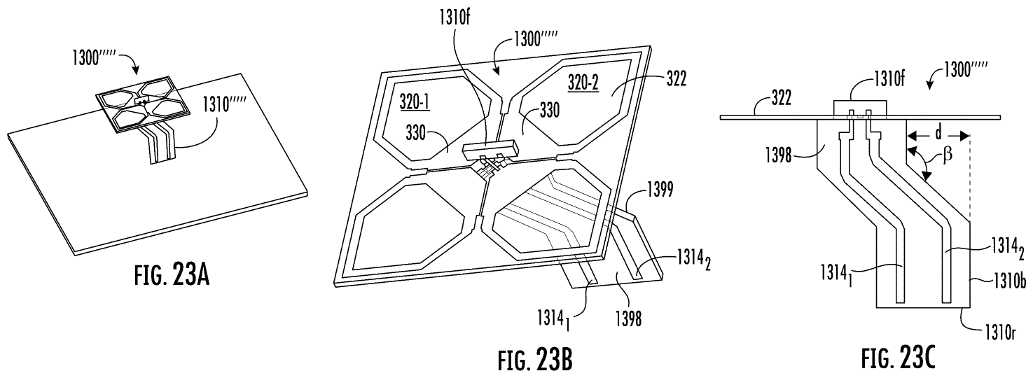

Turning now to FIGS. 23A-23C, the dual radiating element 1300′″″ can have a feed stalk 1310′″″ configured to cooperate with the dipole arms 330 to provide the orthogonal electric fields discussed above with respect to FIGS. 3A-3C. The feed stalk 1310′″″ can be a single piece printed circuit board that provides an angled stalk configuration that has a planar bottom segment that angles at an angle “β” over its length (in a front to back direction of the base station antenna) to position the front portion 1310f laterally or longitudinally offset from the base 1310r.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna comprising:
a plurality of dual polarized radiating elements, each dual polarized radiating element comprising:
a first dipole radiator having a first dipole arm and a second dipole arm;
a second dipole radiator having a third dipole arm and a fourth dipole arm; and
a feed stalk that is configured to electrically connect the first and second dipole radiators to a feed network, the feed stalk comprising,
a first signal trace that is configured to feed first radio frequency (“RF”) signals to the first dipole radiator, wherein the first signal trace connects to the first dipole radiator at a first feed connection;
a second signal trace that is configured to feed second RF signals to the second dipole radiator, wherein the second signal trace connects to the second dipole radiator at a second feed connection,
a first ground line connected to the first dipole radiator at a first ground connection,
a second ground line connected to the second dipole radiator at a second ground connection,
wherein a first electric field direction of each first RF signal extends across a center point of the dual polarized radiating element when the dual polarized radiating element is viewed from a front of the base station antenna,
wherein a second electric field direction of each second RF signal extends across the center point of the dual polarized radiating element when the dual polarized radiating element is viewed from the front,
wherein the first electric field direction is orthogonal or substantially orthogonal to the second electric field direction, and
wherein the feed stalk is offset from the center point of the dual polarized radiating element and does not overlap the center point of the dual polarized radiating element.

2. The base station antenna of claim 1, wherein the feed stalk is longitudinally or transversely spaced apart from the center point of the dual polarized radiating element, wherein longitudinally corresponds to a longitudinal direction of the base station antenna and transversely corresponds to a lateral direction, perpendicular to the longitudinal direction, of the base station antenna

3. The base station antenna of claim 1, wherein the feed stalk is provided as a single printed circuit board or a pair of printed circuit boards that extend(s) in a transverse direction and in a front to back direction of the base station antenna, wherein the transverse direction is perpendicular to a longitudinal direction of the base station antenna, and wherein the single printed circuit board or the pair of printed circuit boards have a straight orientation between front and rear ends thereof and is/are longitudinally spaced apart from the center point of the dual polarized radiating element, with the front end positioned forward of and adjacent to a printed circuit board providing the first and second dipole radiators.

4. The base station antenna of claim 1, wherein the feed stalk has a primary body with opposing front and rear ends, the front end positioned adjacent the first and second dipole radiators, and wherein the primary body has a segment that angles transversely between the front and rear ends.

5. The base station antenna of claim 1, wherein the first ground connection is closer to the center point of the dual polarized radiating element than the first feed connection, and wherein the second ground connection is closer to the center point of the dual polarized radiating element than the second feed connection.

6. The base station antenna of claim 1, wherein the feed stalk is a single piece printed circuit board feed stalk has only two signal traces, the first and second signal traces, and only two ground lines, the first and second ground lines.

7. The base station antenna of claim 1, wherein the first and second dipole radiators are provided by a printed circuit board, wherein the feed stalk is provided as a first feed stalk and a second feed stalk, wherein the first feed stalk and the second feed stalk each has a sheet metal body with opposing front and rear end portions, and wherein the sheet metal body has a bend segment closer to the front end portion that bends at an angle of 80-110 degrees with the bend segment behind the printed circuit board.

8. The base station antenna of claim 7, wherein the bend segment is a first bend segment that merges into a second bend segment in front of the first bend segment, wherein the second bend segment of the first feed stalk bends at an angle in a range of 80-110 degrees from the first bend segment to directly define the first ground connection, and wherein the second bend segment of the second feed stalk bends at an angle in a range of 80-110 degrees from the first bend segment to directly define the second ground connection.

9. The base station antenna of claim 8, wherein the first, second, third and fourth dipole arms each comprise a metal pattern on the printed circuit board with respective first, second, third and fourth inner corner regions that comprise a surface area of metal that meet at and extend about the center point of the dual polarized radiating element, wherein the first and second ground connections reside at an outer perimeter portion of two neighboring corner regions of the first, second, third and fourth corner regions, and wherein the first and second feed connections reside at an inner perimeter portion of a different two of the corner regions.

10. The base station antenna of claim 1, wherein the feed stalk is provided as first and second feed stalks, each of the first and second feed stalks comprising opposing front and rear end portions, the front end portion of the first feed stalk configured to provide the first feed connection at a first orientation, the front end portion of the second feed stalk configured to provide the second feed connection at a second orientation that is perpendicular to the first orientation.

11. The base station antenna of claim 10, wherein the first, second, third and fourth dipole arms each comprise a metal pattern on the printed circuit board with respective first, second, third and fourth inner corner regions that comprise a surface area of metal that meet at and extend about the center point of the dual polarized radiating element, wherein the first and second feed connections reside at an inner perimeter portion of two neighboring corner regions of the first, second, third and fourth corner regions, and wherein the first and second ground connections reside closer to the center point of the dual polarized radiating element adjacent or on cross-traces connecting the corner regions.

12. The base station antenna of claim 1, wherein the first dipole radiator and the second dipole radiator are provided by a printed circuit board, wherein the printed circuit board comprises a recess that extends across the center point between the first and second dipole arms or between the second and third dipole arms, and wherein the recess has plated sidewalls.

13. The base station antenna of claim 12, wherein the recess comprises a floor of a dielectric layer of the printed circuit board spanning between the plated sidewalls.

14. The base station antenna of claim 13, wherein the floor comprises a copper layer on a rear surface thereof.

15. The base station antenna of claim 12, wherein the printed circuit board comprises a first a plated through hole and a second plated through hole, both coupled to a copper layer of the feed stalk and configured to electrically connect the first and second dipole arms or the second and third dipole arms, wherein the first and second plated through holes reside on opposing sides of the recess.

16. The base station antenna of claim 15, further comprising a connection pin coupled to the first and second plated through holes and extending across the recess, wherein the connection pin has a width that is less than a width of the recess thereby reducing capacitive coupling between the first and second polarizations.

17. The base station antenna of claim 1, wherein the feed stalk comprises a first primary surface that comprises a copper layer and an opposing second primary surface that comprises the first and/or second signal trace and a copper layer, wherein the dual polarized radiating element comprises a first solder pad on the first dipole radiator and a second solder pad on the second dipole radiator, and wherein the first solder pad has a first surface that is in front of the dual polarized radiating element and that is soldered to the first primary surface of the feed stalk and an opposing second surface that is in front of the dual polarized radiating element and that is soldered to the second primary surface of the feed stalk.

18. The base station antenna of claim 15, wherein the first plated through hole and the second plated through hole provide an electrical path to electrically connect to a ground plane provided by one or more copper layers on the feed stalk defining at least part of the first and/or second ground line.

19. The base station antenna of claim 1, wherein the feed stalk has a printed circuit board body with a first end portion configured to reside adjacent a reflector or frequency selective surface and an opposing second end portion that is adjacent the first and second dipole radiators, and wherein the printed circuit board body has a portion comprising an angle of inclination between the first and second end portions that is between 20 and 75 degrees.

20. The base station antenna of claim 1, wherein the first signal trace and the second signal trace are in a linear trace that is devoid of a balun hook shape and devoid of any rearward turn.

21-22. (canceled)

23. The base station antenna of claim 1, wherein the feed stalk is provided as a pair of cooperating closely spaced apart parallel structures that provide orthogonal electrical feeds as the first and second RF feed connections to a respective dual radiating element.

24. The base station antenna of claim 1, wherein the feed stalk is provided by a pair of cooperating closely spaced apart perpendicular structures that define orthogonal electrical feeds as the first and second RF feed connections to a respective dual radiating element.

25. (canceled)

26. A base station antenna comprising a center-fed cross-dipole radiating element comprising four dipole arms, wherein the center-fed cross-dipole radiating element is configured so that a feed stalk thereof overlaps two of the four dipole arms in the forward direction of the base station antenna but does not overlap the other two of the four dipole arms.

27-29. (canceled)
